(19) United States
(12) Patent Application Publication
(10) Pub. No.: US 2008/0033141 A1
(43) Pub. Date: Feb. 7, 2008

(54) POLY(ARYLENE ETHER) METHOD

(76) Inventors: Gary M. Bates, Voorheesville, NY (US); Carolyn A. Degonzague, Albany, NY (US); Raymond John Gerhart, Niskayuna, NY (US); Hua Guo, Selkirk, NY (US); Zhiqing Lin, Loudonville, NY (US); Thomas P. Mufaie, Ravena, NY (US); Abhijit Namjoshi, Slingerlands, NY (US); John M. Rowe, New Baltimore, NY (US); Nitin Vaish, Evansville, IN (US)

Correspondence Address: CANTOR COLBURN LLP - SABIC (NORYL), 55 GRIFFIN ROAD SOUTH, BLOOMFIELD, CT, 06002, US

(21) Appl. No.: 11/461,486

(22) Filed: Aug. 1, 2006

(51) Int. Cl. C08G 65/38

(52) U.S. Cl. 528/217

(57) ABSTRACT

A method of preparing a capped poly(arylene ether) is described. By controlling the order of addition and rates of addition of reactants, solvent, and catalyst, problems associated with known methods are avoided. The method is particularly suitable for large-scale preparations of a capped poly(arylene ether).

### BACKGROUND OF THE INVENTION

A capped poly(arylene ether) is a poly(arylene ether) in which at least 50% of the free hydroxyl groups present in the corresponding uncapped poly(arylene ether) have been functionalized by reaction with a capping agent. Capped poly(arylene ether)s have demonstrated utility in a variety of curable compositions. For example, U.S. Pat. No. 6,352,782 to Yeager et al. describes a composition comprising a capped poly(arylene ether) and a curable monomer and use of the composition to form circuit board laminates. As another example, U.S. Pat. No. 6,905,637 to Yeager et al. describes a composition comprising a capped poly(arylene ether), an alkenyl aromatic monomer, and acryloyl monomer, and a conductive filler, and use of the composition to form bipolar plates of fuel cells.

Methods of preparing capped poly(arylene ether) are known. For example, U.S. Pat. No. 5,071,922 to Nelissen et al. describes a process for the preparation of a modified polyphenylene ether comprising the reaction of polyphenylene ether with a non-cyclic acid anhydride in the presence of a pyridine derivative substituted by an amine group as catalyst, and in a vinyl substituted aromatic monomer as solvent. As another example, U.S. Pat. No. 6,384,176 to Braat et al. describes reacting a polyphenylene ether resin with an unsaturated compound to form a polyphenylene ether containing aliphatic unsaturation, and isolating the polyphenylene ether containing aliphatic unsaturation using a total isolation method.

The increasing commercial use of capped poly(arylene ether)s has created a need for an industrial-scale preparation method. However, as described in detail below, various problems were encountered with scaling up known methods. There is therefore a need for a scalable method for efficiently preparing capped poly(arylene ether)s.

### BRIEF DESCRIPTION OF THE INVENTION

One embodiment is a method of preparing a capped poly(arylene ether), comprising: adjusting the temperature of a solvent to a temperature in the range of about 30° C. to an atmospheric boiling point of the solvent; combining a poly(arylene ether) with the temperature-adjusted solvent and agitating to at least partially dissolve the poly(arylene ether); combining a capping catalyst with the combined poly(arylene ether) and solvent; combining a capping agent with the combined poly(arylene ether), solvent, and capping catalyst; and maintaining the combined capping agent, poly(arylene ether), solvent, and capping catalyst at about 60 to about 150° C. for about 40 to about 120 minutes to form a solution of the capped poly(arylene ether).

One embodiment is a method of preparing a capped poly(arylene ether), comprising: adjusting the temperature of an aromatic hydrocarbon solvent to a temperature in the range of about 40 to about 80° C.; wherein the aromatic hydrocarbon solvent is selected from the group consisting of toluene, styrene, and mixtures thereof; combining a poly(arylene ether) with the temperature-adjusted solvent and agitating to dissolve at least 95 weight percent of the poly(arylene ether); wherein said combining a poly(arylene ether) with the temperature-adjusted solvent comprises adding the poly(arylene ether) to the solvent at a rate of about 0.4 to about 2 weight percent of the total poly(arylene ether) per minute; and wherein said combining a poly(arylene ether) is conducted in an atmosphere comprising less than or equal to 10 kilopascals partial pressure of molecular oxygen; combining a capping catalyst with the combined poly(arylene ether) and solvent; wherein the capping catalyst comprises 4-dimethylaminopyridine; combining a capping agent with the combined poly(arylene ether), solvent, and capping catalyst; wherein the capping agent is selected from the group consisting of acrylic anhydride, methacrylic anhydride, and mixtures thereof; and maintaining the combined capping agent, poly(arylene ether), solvent, and capping catalyst at about 70 to about 100° C. for about 40 to about 120 minutes to form a solution of the capped poly(arylene ether).

One embodiment is a method of preparing a capped poly(arylene ether), comprising: adjusting the temperature of an aromatic hydrocarbon solvent to a temperature in the range of about 40 to about 80° C.; wherein the aromatic hydrocarbon solvent is selected from the group consisting of toluene, styrene, and mixtures thereof; combining a poly(arylene ether) with the temperature-adjusted solvent and agitating to dissolve at least 95% of the poly(arylene ether); wherein said combining a poly(arylene ether) is conducted in an atmosphere comprising less than 10 kilopascals partial pressure of molecular oxygen; wherein said combining a poly(arylene ether) with the temperature-adjusted solvent comprises adding the poly(arylene ether) to the solvent at a rate of about 0.4 to about 2 weight percent of the total poly(arylene ether) per minute; and wherein the solvent and the poly(arylene ether) are used in a weight ratio of about 1:1 to about 3:1; combining a capping catalyst with the combined poly(arylene ether) and solvent; wherein the capping catalyst comprises 4-dimethylaminopyridine; wherein the capping agent and the capping catalyst are used in a molar ratio of about 4:1 to about 10:1, and wherein the poly(arylene ether) and the capping agent are used in amounts such that a molar ratio of capping agent to hydroxy groups in the poly(arylene ether) is about 2:1 to about 4:1; combining a capping agent with the combined poly(arylene ether), solvent, and capping catalyst; wherein the capping agent comprises methacrylic anhydride; and maintaining the combined capping agent, poly(arylene ether), solvent, and capping catalyst at about 70 to about 100° C. for about 40 to about 120 minutes to form a solution of the capped poly(arylene ether).

Other embodiments are described in detail below.

### DETAILED DESCRIPTION OF THE INVENTION

The present inventors conducted extensive research to discover a method of preparing a capped poly(arylene ether) that could be utilized on any scale ranging from laboratory scale to industrial scale. Attempts to scale up known synthetic methods encountered various problems. For example, simply combining a poly(arylene ether) and solvent on a large scale resulted in formation of an intractable mass of poly(arylene ether) that was very slow to dissolve. It was also found that molar ratios of reactants that were suitable on a small scale resulted in low yields of the capped poly(arylene ether) when the reaction was scaled up. Furthermore, it was found that the order of addition of reactants and catalysts strongly affected the product yield in large-scale reactions. After extensive experimentation, the present inventors have found a scalable method of preparing a capped poly(arylene ether) that comprises adjusting the temperature of a solvent to a temperature in the range of about 30° C. to an atmospheric boiling point of the solvent; combining a poly(arylene ether) with the temperature-adjusted solvent and agitating to at least partially dissolve the poly(arylene ether); combining a capping catalyst with the combined poly(arylene ether) and solvent; combining a capping agent with the combined poly(arylene ether), solvent, and capping catalyst; and maintaining the combined capping agent, poly(arylene ether), solvent, and capping catalyst at about 60 to about 150° C. for about 40 to about 120 minutes to form a solution of the capped poly(arylene ether).

There is no particular limit on the apparatus used to practice the method. For example, the method may be carried out in reactors having exposed surfaces of glass or stainless steel. As described below, the apparatus may comprise equipment to facilitate gradual addition of poly(arylene ether) to solvent. The apparatus may also comprise equipment to control the pressure and composition of the atmosphere over the liquid reaction mixture. The apparatus may further comprise equipment for gradual addition of the capping agent to the combined poly(arylene ether), solvent, and capping catalyst.

The method comprises adjusting the temperature of a solvent to a temperature in the range of about 30° C. to an atmospheric boiling point of the solvent. The atmospheric boiling point of the solvent will of course depend on the composition of a solvent. Various suitable solvents are described below. When a mixed solvent is used, the temperature may be as high as the atmospheric boiling point of the lowest boiling solvent in the solvent mixture. In some embodiments, the solvent may be adjusted to a temperature of at least about 40° C., or at least about 50° C., or at least about 60° C. In some embodiments, the solvent may be adjusted to a temperature of up to about 180° C., or up to about 150° C., or up to about 120° C., or up to about 100° C., or up to about 80° C., or up to about 70° C. The method may also comprise adjusting the pressure of the headspace over the reaction mixture. The total pressure or the pressure of particular component gases, such as oxygen, may be adjusted.

In some embodiments, combining the poly(arylene ether) with the temperature-adjusted solvent comprises adding the poly(arylene ether) to the solvent at a rate of about 0.4 to about 2 weight percent of the total poly(arylene ether) per minute. Within this range, the addition rate may be at least about 0.6 weight percent per minute. Also within this range, the addition rate may be up to about 1.6 weight percent per minute. The average addition rate, in weight percent per minute, may be calculated by dividing 100 (corresponding to 100 percent of the total poly(arylene ether)) by the total time in minutes elapsed between the beginning and end of poly(arylene ether) addition. In some embodiments, the poly(arylene ether) is added to the temperature-adjusted solvent in at least two separate steps, or at least three separate steps, or at least four separate steps, or at least five separate steps. In some embodiments, the poly(arylene ether) is provided in both powder and pellet form, and these two forms are added alternately with pellets being the last form of poly(arylene ether) that gets added in order to complete the addition of any powder that may have adhered to the walls of the addition apparatus. For example, the addition sequence may be powder followed by pellets followed by powder followed by pellets, with additions separated in time to allow dissolution of the last added poly(arylene ether).

In some embodiments, the poly(arylene ether) may be pre-dissolved in a solvent before it is combined with the temperature-adjusted solvent. In other words, in these embodiments, the poly(arylene ether) is in the form of a poly(arylene ether) solution when it is combined with the temperature-adjusted solvent. The solvent used to form the solution may be any of the solvents described below as suitable for use as the temperature-adjusted solvent.

In some embodiments, combining the poly(arylene ether) with the temperature-adjusted solvent is conducted in an atmosphere comprising less than or equal to 10 kilopascals partial pressure of molecular oxygen. Oxygen partial pressures less than or equal to 8 kilopascals, or less than or equal to 6 kilopascals, or less than or equal to 4 kilopascals may also be used.

In some embodiments, the total headspace pressure during combination of the poly(arylene ether) with the solvent is in the range of about 8 kilopascals to about 101 kilopascals. Use of total pressures greater than 101 kilopascals may under some circumstances allow solvent vapors to enter the poly(aryiene ether) addition system and form clogs by partially dissolving the poly(arylene ether) in that system. Depending on the solvent employed, total pressures less than or equal to 8 kilopascals may cause undesirable solvent boiling. After the poly(arylene ether) and the solvent have been combined, pressures greater than 101 kilopascals may be used. For example, the headspace absolute pressure may be as high as about 450 kilopascals.

In some embodiments, the poly(arylene ether) is combined with the temperature-adjusted solvent by adding the poly(arylene ether) to the solvent via an apparatus comprising a dispensing valve with an open/close controller, and a nitrogen-purged conduit. The apparatus may, optionally, further comprise a hopper to store the poly(arylene ether) prior to addition, and a rotary valve. Such an apparatus facilitates stepwise addition of the poly(arylene ether).

Once the poly(arylene ether) and solvent are combined, the resulting mixture is agitated to at least partially dissolve the poly(arylene ether). In some embodiments, the combined poly(arylene ether) and solvent are agitated at about 50 to about 100° C. for about 10 to about 100 minutes. Within the above temperature range, the temperature may be at least about 60° C., or up to about 90° C., or up to about 80° C., or up to about 70° C. Within the above time range, the time may be at least about 20 minutes, or up to about 80 minutes.

In some embodiments, agitating to at least partially dissolve the poly(arylene ether) comprises mixing with a mixing energy of about 10 to about 50 kilojoules per kilogram total of poly(arylene ether) and solvent. Agitating may further comprise heating the combined poly(arylene ether) and solvent with a heating energy of about 100 to about 250 kilojoules per kilogram total of poly(arylene ether) and solvent. Within this range, the heating energy may be at least about 130 kilojoules per kilogram, or up to about 200 kilojoules per kilogram.

In some embodiments, agitating may be effective to dissolve at least about 80 weight percent of the poly(arylene ether), or at least about 90 weight percent of the poly(arylene ether), or at least about 95 weight percent of the poly(arylene ether), or at least about 98 weight percent of the poly(arylene ether), or at least about 99 weight percent of the poly(arylene ether). The extent of poly(arylene ether) dissolution may be determined by removing a solid-free sample of the solution, removing the solvent under vacuum, weighing the residual solid (poly(arylene ether)), and comparing the weight percent of residual solid to the theoretical weight percent of poly(arylene ether) based on the masses of poly(arylene ether) and solvent employed. This method is described in detail in the working examples, below.

Once the poly(arylene ether) and the solvent have been combined and the poly(arylene ether) has been at least partially dissolved via agitation, a capping catalyst is combined with the poly(arylene ether) and solvent. Suitable capping catalysts are described below. The present inventors have found that the reaction rate and yield are not sensitive to the rate of addition of capping catalyst. For example, all of the capping catalyst may be added rapidly without any adverse effect. In some embodiments, the capping catalyst may be dissolved in solvent before it is combined with the poly(arylene ether) and solvent.

After the solvent, poly(arylene ether), and capping catalyst have all been combined, the resulting mixture is combined with a capping agent. Suitable capping agents are described below. Reaction of the capping agent with the poly(arylene ether) hydroxy groups may be exothermic. Thus, in some embodiments, combining the capping agent comprises adding the capping agent to the poly(arylene ether), solvent, and capping catalyst at a rate effective to maintain a temperature no more than 10° C. greater than a temperature in the absence of capping agent addition. The maintained temperature may be no more than 6° C. greater than a temperature in the absence of capping agent addition, or no more than 4° C. greater than a temperature in the absence of capping agent addition, or no more than 2° C. greater than a temperature in the absence of capping agent addition. In some embodiments, the capping agent is added over the course of about 10 to about 45 minutes.

In some embodiments, the capping agent is used in an amount that comprises an excess to compensate for a water impurity in at least one of the solvent, the poly(arylene ether), and the capping catalyst. In some embodiments, the capping agent is used in an amount of at least 0.8 mole of capping agent per 1 mole total for the sum of moles of phenolic end groups in the poly(arylene ether), moles of water in the poly(arylene ether), and moles of water in the solvent. When less than complete capping of the hydroxy groups on the poly(arylene ether) is desired, the number of moles of capping agent used may be less than 1 mole per 1 mole total for the sum of moles of phenolic end-groups in the poly(arylene ether), moles of water in the poly(arylene ether), and moles of water in the solvent. The number of moles of the capping agent used per 1 mole total for the sum of moles of phenolic end-groups in the poly(arylene ether), moles of water in the poly(arylene ether), and moles of water in the solvent may also be at least 1, at least 1.3, at least 1.4, or at least 1.48 moles. The excess of the capping agent may also be adjusted to account for other sources of reactive hydroxy groups such as, for example, small amounts of water present in the reactor before it is charged with solvent and poly(arylene ether), or phenolic end groups associated with stabilizers (for example, the hydroxy groups of 4-tert-butylcatechol stabilizer present in styrene solvent). Of course, the reactor may also be freed of water contamination by, for example, heating and purging with a water-free gas.

The solvent may be any solvent that is effective to dissolve the poly(arylene ether). Suitable solvents include, for example, halogenated aliphatic hydrocarbon solvents, aromatic hydrocarbon solvents, halogenated aromatic hydrocarbon solvents, and mixtures thereof. Specific aromatic hydrocarbon solvents include, for example, benzene, toluene, ethylbenzene, xylenes, styrene, vinyltoluenes, divinylbenzenes, and the like, and mixtures thereof. Specific halogenated aromatic hydrocarbon solvents include, for example, chlorobenzene, dichlorobenzenes, trichlorobenzenes, and the like, and mixtures thereof. Specific halogenated aliphatic hydrocarbon solvents include, for example, trichloromethane, tetrachloromethane, dichloroethanes, trichloroethanes, tetrachloroethanes, pentachloroethanes, hexachloroethane, dichloroethylenes, trichloroethylene, tetrachloroethylene, and the like, and mixtures thereof. In some embodiments, the solvent is toluene. In some embodiments, the solvent is styrene. In some embodiments the water content of the solvent is less than about 2,000 parts per million by weight, or less than about 1,400 parts per million by weight, or less than about 800 parts per million by weight, or less than about 200 parts per million by weight.

When the solvent is a polymerizable aromatic solvent such as styrene, a vinyltoluene, a divinylbenzene, or mixtures thereof, the method may, optionally, further comprise combining a polymerization inhibitor with the solution of the capped poly(arylene ether). Suitable polymerization inhibitors include, for example, diazoaminobenzene, phenylacetylene, sym-trinitrobenzene, p-benzoquinone, acetaldehyde, aniline condensates, N,N′-dibutyl-o-phenylenediamine, N-butyl-p-aminophenol, 2,4,6-triphenylphenoxyl, pyrogallol, catechol, hydroquinone, monoalkylhydroquinones, p-methoxyphenol, t-butylhydroquinone, C₁-C₆-alkyl-substituted catechols (such as t-butylcatechol), dialkylhydroquinones, 2,4,6-dichloronitrophenol, halogen-ortho-nitrophenols, alkoxyhydroquinones, mono- and di- and polysulfides of phenols and catechols, thiols, oximes and hydrazones of quinone, phenothiazine, dialkylhydroxylamines, and mixture thereof. When present, the inhibitor may be used in an amount of about 50 to about 1,000 parts per million by weight, based on the total weight of the capped poly(arylene ether) and the polymerizable aromatic solvent.

The poly(arylene ether) used in the method may be any poly(arylene ether) comprising terminal phenolic groups. Both the poly(arylene ether) starting material and the capped poly(arylene ether) product may comprise repeating structural units having the formula

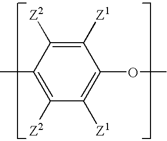

wherein for each structural unit, each Z¹ is independently halogen, unsubstituted or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; and each Z² is independently hydrogen, halogen, unsubstituted or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms. As used herein, the term “hydrocarbyl”, whether used by itself, or as a prefix, suffix, or fragment of another term, refers to a residue that contains only carbon and hydrogen. The residue may be aliphatic or aromatic, straight-chain, cyclic, bicyclic, branched, saturated, or unsaturated. It may also contain combinations of aliphatic, aromatic, straight chain, cyclic, bicyclic, branched, saturated, and unsaturated hydrocarbon moieties. However, when the hydrocarbyl residue is described as “substituted”, it may contain heteroatoms over and above the carbon and hydrogen members of the substituent residue. Thus, when specifically described as substituted, the hydrocarbyl residue may also contain halogen atoms, nitro groups, cyano groups, carbonyl groups, carboxylic acid groups, ester groups, amino groups, amide groups, sulfonyl groups, sulfoxyl groups, sulfonamide groups, sulfamoyl groups, hydroxy groups, alkoxyl groups, or the like, and it may contain heteroatoms within the backbone of the hydrocarbyl residue.

In some embodiments, the capped poly(arylene ether) comprises 2,6-dimethyl-1,4-phenylene ether units, 2,3,6-trimethyl-1,4-phenylene ether units, or a combination thereof.

In some embodiments, the capped poly(arylene ether) is a monocapped poly(arylene ether) having the structure

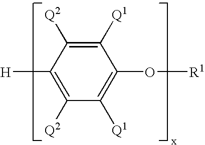

wherein x is 5 to about 100; each occurrence of Q¹ is independently halogen, unsubstituted or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; each occurrence of Q² and R⁶ and R⁷ is independently hydrogen, halogen, unsubstituted or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; and R¹ has the structure

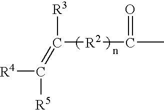

wherein n is 0 or 1, R² is C₁-C₁₂ hydrocarbylene, and R² and R³ and R⁴ are each independently hydrogen or C₁-C₁₈ hydrocarbyl.

In some embodiments, the capped poly(arylene ether) is a bicapped poly(arylene ether) having the structure

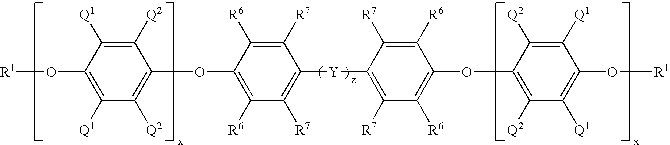

wherein z is 0 or 1; each occurrence of x is independently 1 to about 100; each occurrence of Q¹ is independently halogen, unsubstituted or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; each occurrence of Q² and R⁶ and R⁷ is independently hydrogen, halogen, unsubstituted or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; each occurrence of R¹ is independently

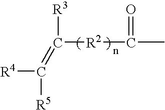

wherein n is 0 or 1, R² is C₁-C₁₂ hydrocarbylene, and R² and R³ and R⁴ are each independently hydrogen or C₁-C₁₈ hydrocarbyl; and Y has a structure selected from

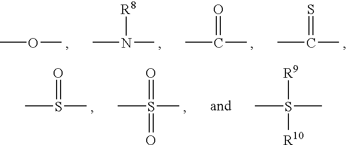

wherein each occurrence of R⁸, R⁹, and R¹⁰ is independently selected from hydrogen and C₁-C₁₂ hydrocarbyl.

In some embodiments, the capped poly(arylene ether) has the structure

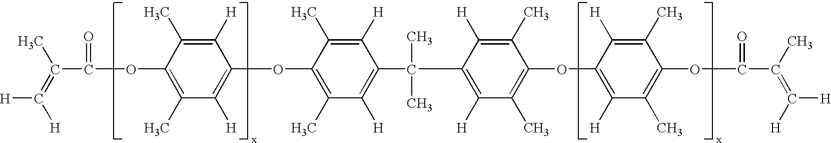

wherein each occurrence of x is independently 1 to about 50. Such a capped poly(arylene ether) may be prepared, for example, by starting with a poly(arylene ether) prepared by copolymerization of 2,6-dimethyphenol and 2,2-bis(3,5-dimethyl-4-hydroxyphenyl)propane, and capping that poly(arylene ether) starting material with methacrylic anhydride.

In some embodiments, the poly(arylene ether) has an intrinsic viscosity of about 0.05 to about 1.0 deciliter per gram, measured at 25° C. in chloroform. Within this range, the poly(arylene ether) may have an intrinsic viscosity of at least about 0.1 deciliter per gram, or at least about 0.2 deciliter per gram. Also within this range, the poly(arylene ether) may have an intrinsic viscosity of up to about 0.6 deciliter per gram, or up to about 0.4 deciliter per gram.

The poly(arylene ether) starting material may be a blend of two or more poly(arylene ether)s having different intrinsic viscosities. For example, the poly(arylene ether) may comprise a first poly(arylene ether) having an intrinsic viscosity of about 0.05 to less than 0.2 deciliter per gram and a second poly(arylene ether) having an intrinsic viscosity of 0.2 to about 0.6 deciliter per gram, wherein the intrinsic viscosities are measured at 25° C. in chloroform. In some embodiments, poly(arylene ether) is in pellet form with a smallest dimension of about 1 to about 5 millimeters. Within this range, the smallest dimension may be at least about 2 millimeters.

The capping catalyst may be any compound capable of catalyzing the reaction between the poly(arylene ether) and the capping agent. Suitable capping catalysts include dialkylaminopyridines, pyrollidinopyridines, and mixtures thereof. In some embodiments, the capping catalyst is 4-dimethylaminopyridine (DMAP).

The capping agent generally includes at least one group capable of reacting with the phenolic hydroxy group of the poly(arylene ether) and at least one carbon-carbon double bond or triple bond capable of subsequent polymerization. In some embodiments, the capping agent has the structure

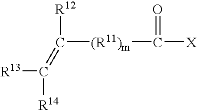

wherein each occurrence of R¹¹ is C₁-C₁₂ hydrocarbylene; each occurrence of R¹² is independently hydrogen or methyl; each occurrence of R¹³ and R¹⁴ are independently hydrogen or C₁-C₁₂ hydrocarbyl; m is 0 or 1; and X is selected from the group consisting of

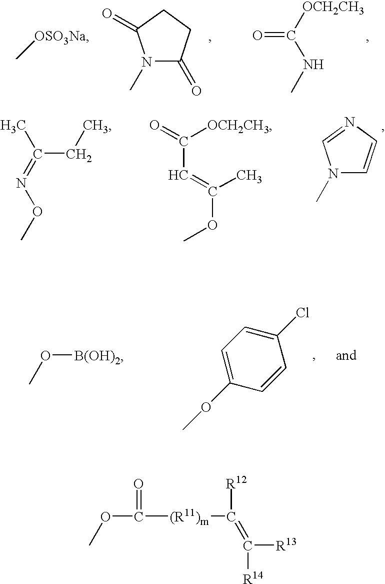

wherein R¹¹, R¹², R¹³, R¹⁴, and m are defined as above. In some preferred embodiments, the capping agent is acrylic anhydride, methacrylic anhydride, or a combination thereof.

The reaction mixture components may be used in fairly broad weight or molar ratios. In some embodiments, the solvent and the poly(arylene ether) are used in a weight ratio of about 1:3 to about 9:1. Within this range, the weight ratio may be at least about 1:1, up to about 6:1, or up to about 3:1. In some embodiments, the capping agent and the capping catalyst are used in a molar ratio of about 4:1 to about 10:1. In some embodiments, the poly(arylene ether) and the capping agent are used in amounts such that the molar ratio of capping agent to hydroxy groups in the poly(arylene ether) is about 1.5:1 to about 5:1. Within this range, the molar ratio may be at least about 2:1, or at least about 2.5:1, or up to about 4:1.

The reaction may be monitored by monitoring the consumption of the poly(arylene ether) starting material. For example, the intensity of an infrared absorbance associated with poly(arylene ether) phenolic hydroxy groups may be monitored.

The method may, optionally, further include isolating the capped poly(arylene ether) from solution. Suitable methods for isolating the capped poly(arylene ether) include spray drying, precipitation, total isolation, devolatilizing extrusion, and combinations thereof. For example, the capped poly(arylene ether) may be precipitated by combining the capped poly(arylene ether) solution with an antisolvent, where the weight ratio of aromatic hydrocarbon solvent in the poly(arylene ether) solution to antisolvent is about 2:1 to about 5:1. Suitable antisolvents include lower alkano is having one to about ten carbon atoms, such as methanol, and the like; ketones having three to about ten carbon atoms, such as acetone, and the like; and alkanes having five to about ten carbon atoms, such as hexane; and the like; and combinations thereof. A preferred antisolvent comprises methanol, ethanol, n-propanol, isopropanol, n-butanol, isobutanol, t-butanol, or the like, or a mixture thereof in one embodiment the antisoivent comprises methanol and at least one C₃-C₆ alkanol. Suitable C₃-C₆ alkanols include, for example, n-propanol, isopropanol, n-butanol, isobutanol, t-butanol, n-pentanol, 2-methyl-1-butanol, 2-methyl-2-butanol, 3-methyl-1-butanol, 3-methyl-2-butanol, 2,2-dimethyl- 1-propanol (neopentyl alcohol), cyclopentanol, 1-hexanol, 2-hexanol, 3-hexanol, 2-methyl-1-pentanol, 2-methyl-2-pentanol, 2-methyl-3-pentanol, 4-methyl-1-pentanol, 4-methyl-2-pentanol, 3-methyl-1-pentanol, 3-methyl-2-pentanol, 3-methyl-3-pentanol, 2-ethyl-1-butanol, 2,3-dimethyl-1-butanol, 2,3-dimethyl-2-butanol, 2,2-dimethyl-1-butanol, 3,3-dimethyl-1-butanol, 3,3-dimethyl-2-butanol, cyclopentylmethanol, 1-methylcyclopentanol, 2-methylcyclopentanol, 3-methylcyclopentanol, cyclohexanol, and the like, and mixtures thereof. In another embodiment, the antisolvent comprises (a) methanol, and (b) isopropanol, n-butanol, or a mixture thereof. A highly preferred antisolvent comprises methanol.

One embodiment is a method of preparing a capped poly(arylene ether), comprising: adjusting a temperature of an aromatic hydrocarbon solvent to about 40 to about 80° C., wherein the aromatic hydrocarbon solvent is selected from the group consisting of toluene, styrene, and mixtures thereof; combining a poly(arylene ether) with the temperature-adjusted solvent and agitating to dissolve at least 95 weight percent of the poly(arylene ether); wherein said combining a poly(arylene ether) with the temperature-adjusted solvent comprises adding the poly(arylene ether) to the solvent at a rate of about 0.4 to about 2 weight percent of the total poly(arylene ether) per minute; and wherein said combining a poly(arylene ether) is conducted in an atmosphere comprising less than or equal to 10 kilopascals partial pressure of molecular oxygen; combining a capping catalyst with the combined poly(arylene ether) and solvent, wherein the capping catalyst comprises 4-dimethylaminopyridine; combining a capping agent with the combined poly(arylene ether), solvent, and capping catalyst, wherein the capping agent is selected from the group consisting of acrylic anhydride, methacrylic anhydride, and mixtures thereof; and maintaining the combined capping agent, poly(arylene ether), solvent, and capping catalyst at about 70 to about 100° C. for about 40 to about 120 minutes to form a solution of the capped poly(arylene ether).

One embodiment is a method of preparing a capped poly(arylene ether), comprising: adjusting a temperature of an aromatic hydrocarbon solvent to about 40 to about 80° C.; wherein the aromatic hydrocarbon solvent is selected from the group consisting of toluene, styrene, and mixtures thereof; combining a poly(arylene ether) with the temperature-adjusted solvent and agitating to dissolve at least 95% of the poly(arylene ether); wherein said combining a poly(arylene ether) is conducted in an atmosphere comprising less than 10 kilopascals partial pressure of molecular oxygen; wherein said combining a poly(arylene ether) with the temperature-adjusted solvent comprises adding the poly(arylene ether) to the solvent at a rate of about 0.4 to about 2 weight percent of the total poly(arylene ether) per minute; and wherein the solvent and the poly(arylene ether) are used in a weight ratio of about 1:1 to about 3:1; combining a capping catalyst with the combined poly(arylene ether) and solvent, wherein the capping catalyst comprises 4-dimethylaminopyridine; wherein the capping agent and the capping catalyst are used in a molar ratio of about 4:1 to about 10:1, and wherein the poly(arylene ether) and the capping agent are used in amounts such that a molar ratio of capping agent to hydroxy groups in the poly(arylene ether) is about 2:1 to about 4:1; combining a capping agent with the combined poly(arylene ether), solvent, and capping catalyst; wherein the capping agent comprises methacrylic anhydride; and maintaining the combined capping agent, poly(arylene ether), solvent, and capping catalyst at about 70 to about 100° C. for about 40 to about 120 minutes to form a solution of the capped poly(arylene ether).

The invention is further illustrated by the following non-limiting examples.

### EXAMPLE 1

This example describes a typical procedure for the capping of a poly(arylene ether) with methacrylic anhydride. The reaction is conducted in toluene solvent in the presence of 4-dimethylaminopyridine catalyst.

The toluene solvent had a purity of at least 99.9% and a water content less than 100 parts per million by weight. A poly(2,6-dimethyl-1,4-phenylene ether) having an intrinsic viscosity of 0.12 deciliter per gram in chloroform at 25° C. was obtained as PPO* SA120 from GE Plastics and used as received. 4-Dimethylaminopyridine (DMAP) was obtained in prilled form from Riley Industries and used as received. Methacrylic anhydride was obtained from Degussa and used as received. Component amounts are summarized in Table 1.

TABLE 1

| Component | Weight (kg) | Moles |
|---|---|---|
| Toluene | 323.6 | — |
| Poly(arylene ether) | 323.3 | * |
| DMAP | 3.36 | 27.5 |
| Methacrylic anhydride | 48.5 | 315 |

* equivalent to 130.55 moles phenolic hydroxy groups. This is calculated as follows: (6865 ppm OH) × 323.3 × 1000/(17 × 10⁶)

Prior to the reaction, the water content of the toluene solvent was determined by gas chromatography (GC) with thermal conductivity detector. Excess methacrylic anhydride was added to compensate for the water content of the solvent. The concentration of phenolic end groups in the poly(2,6-dimethyl-1,4-phenylene ether) was determined by Fourier transform infrared spectroscopy (FTIR) using 2,6-dimethylphenol standards. The reaction vessel was a 1,136 liter (300 gallon), stainless steel vessel equipped with agitator, heat exchanger, poly(arylene ether) addition system, catalyst addition system, and capping agent addition system. Prior to use, the vessel was dried (freed of significant water) by blowing dry nitrogen through the vessel.

The reaction vessel was flushed with nitrogen. Toluene (271 kilograms, 598 pounds) was added to the vessel, and the agitator was turned on. The toluene was heated via a heat exchanger to 65.6° C. (150° F.). The poly(arylene ether) (323.3 kilograms, 712.7 pounds) was added at a rate of about 2.3 to 6.8 kilograms per minute (about 5 to 15 pounds per minute) using an addition system including a rotary valve operating at about 3 to 10 rotations per minute, an addition line purged with nitrogen, and a block valve. Gradual, stepwise addition of the poly(arylene ether) reduces obstruction of the addition line.

The temperature of the toluene/poly(arylene ether) mixture was increased to 85° C. (185° F.), and the mixture was agitated for 30 minutes. At the end of 30 minutes, about 50-200 milliliters of solution were removed from the vessel, and the percent dissolved solids was determined by weighing the solution sample, evaporating the toluene at 135° C. and 508-635 millimeters (20-25 inches) mercury vacuum, and weighing the residual solid. If the percent dissolved solids (calculated as 100×(residual solid weight)/(solution weight)) is not within 0.5% of the target value of 47%, then the mixture should be agitated for an additional 15 minutes at 85° C. before determining the percent solids again. This procedure is repeated until the percent dissolved solids value is within 0.5% of the target value.

When the target percent solids value of 47.0±0.5% is achieved, then 4-dimethylaminopyridine (2.72 kilograms, 6 pounds, 22.28 moles) was added step-wise via a dedicated addition system comprising a hopper, a double block valve, and a nitrogen purge. The operation sequence for DMAP addition was as follows: (1) close bottom valve and close nitrogen purge valve; (2) open top valve and load 1.86 kilograms (3 pounds) of DMAP to the DMAP hopper; (3) close the top valve; (4) open the bottom valve; (5) open the nitrogen purge valve to push the DMAP into the reactor; and (6) repeat steps 1-5 until all DMAP is added. The DMAP dissolves rapidly after addition.

The capping agent, methacrylic anhydride, was added via a dedicated addition system comprising a pump, flow meter, and control valve. The flow rate was adjusted via the control valve to allow addition of the methacrylic anhydride over the course of about 20 minutes. During addition of the methacrylic anhydride, the temperature of the reaction mixture was monitored. If the reaction temperature rose more than 5.6° C. (10° F.), the addition rate was slowed.

After addition of the methacrylic anhydride was complete, the reaction mixture was maintained at 85° C. (185° F.) for 75 minutes. After the 75 minutes, a sample of the reaction mixture was removed from the vessel and analyzed by FTIR to determine the concentration of residual phenolic hydroxy groups associated with uncapped poly(arylene ether). The reaction is considered complete if the concentration of hydroxy groups is less than 50 parts per million by weight based on the weight of the poly(arylene ether) starting material. If this is the first determination of hydroxy group concentration, or if the concentration of hydroxy groups is greater than or equal to 50 parts per million by weight, the reaction is continued at 85° C. for an additional 15 minutes, and a second measurement of residual phenolic hydroxy groups is conducted. The reaction is then continued for at least one more 15 minute period. The reaction is considered complete when two consecutive samples give a phenolic hydroxy group concentration less than 50 parts per million by weight (ppm). Although it is possible to add additional capping agent at this stage of the reaction, such addition is typically unnecessary.

The capped poly(arylene ether) was isolated by precipitation. A 189 liter (50 gallon) precipitation tank was charged with 132 liter (35 gallons) of a 3:1 weight/weight mixture of methanol and toluene, which was adjusted to a temperature of about 4 to about 29° C. (about 40 to about 85° F.). Into the precipitation tank were pumped the reaction mixture at a temperature of about 85° C. (about 185° F.) at a rate of 4.54 kilograms per minute (10 pounds per minute), and methanol at a temperature of about 4 to about 29° C. (about 40 to about 85° F.) at a rate sufficient to maintain a methanol:toluene weight ratio of 3:1 in the tank (about 14 kilograms per minute (about 30 pounds per minute)). Overflow from the precipitation tank was held in an agitated tank until the polymer solution was exhausted. The combined contents of the precipitation tank and the overflow tank were pumped to a rotary vacuum filter, which produced a wet cake of precipitated capped poly(arylene ether) that washed with methanol and redispersed in methanol.

The slurry of redispersed precipitate was then fed to a centrifuge, which point separated the precipitate as a wet-cake, which was then fed via a screw conveyer to a paddle dryer.

The isolated, capped poly(arylene ether) had a hydroxy group concentration of 26 parts per million by weight.

### EXAMPLE 2

This example describes the methacrylate capping of a blend of poly(arylene ether) resins in styrene. The poly(arylene ether) resin was a blend of (1) 49.4 kilograms (109.0 pounds) of poly(2,6-dimethyl-1,4-phenylene ether) having an intrinsic viscosity of 0.12 deciliter per gram obtained as PPO* SA120 from GE Plastics, and (2) 111.7 kilograms (246.3 pounds) of poly(2,6-dimethyl-1,4-phenylene ether) having an intrinsic viscosity of 0.30 deciliter per gram obtained as PPO* 630 from GE Plastics. The solvent was styrene having a minimum purity of 99.8 weight percent, a maximum water content of 300 parts per million by weight, and 10-15 parts per million by weight (ppm) of 4-t-butylcatechol as a polymerization inhibitor. In addition to the 4-t-butylcatechol in the styrene as supplied, additional 4-t-butylcatechol was added to bring the total inhibitor concentration to 0.42 weight percent. Component amounts are summarized in Table 2. The reaction procedure of Example 1 was used, except for four differences. First, the solvent was styrene rather than toluene. Second, the above-specified blend of two poly(arylene ether)s was used. Third, at the end of the reaction, t-butylcatechol (in addition to that present in the styrene solvent) was added to stabilize the mixture against undesired polymerization. Fourth, at the end of the capping reaction and after addition of t-butylcatechol, the reaction mixture was pumped to drums rather than being precipitated.

TABLE 2

| Component | Weight (kg) | Moles |
|---|---|---|
| Styrene | 248.0 | — |
| Poly(arylene ether), 0.30 dL/g | 111.7 | —* |
| Poly(arylene ether), 0.12 dL/g | 49.4 | —** |
| DMAP | 1.36 | 11.13 |
| Methacrylic anhydride | 11.52 | 74.73 |
| t-Butylcatechol | 1.05 | 6.30 |

*8.21 moles phenolic hydroxy groups
*20.06 moles phenolic hydroxy groups

The isolated, capped poly(arylene ether) had a hydroxy group concentration of 24 parts per million by weight.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

All ranges disclosed herein are inclusive of the endpoints, and the endpoints are independently combinable with each other.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

1. A method of preparing a capped poly(arylene ether), comprising:
adjusting the temperature of a solvent to a temperature in the range of about 30° C. to an atmospheric boiling point of the solvent;
combining a poly(arylene ether) with the temperature-adjusted solvent and agitating to at least partially dissolve the poly(arylene ether);
combining a capping catalyst with the combined poly(arylene ether) and solvent;
combining a capping agent with the combined poly(arylene ether), solvent, and capping catalyst; and
maintaining the combined capping agent, poly(arylene ether), solvent, and capping catalyst at about 60 to about 150° C. for about 40 to about 120 minutes to form a solution of the capped poly(arylene ether).

2. The method of claim 1, wherein said combining a poly(arylene ether) with the temperature-adjusted solvent comprises adding the poly(arylene ether) to the solvent at a rate of about 0.4 to about 2 weight percent of the total poly(arylene ether) per minute.

3. The method of claim 1, wherein said combining a poly(arylene ether) with the temperature-adjusted solvent comprises combining a poly(arylene ether) solution with the temperature-adjusted solvent.

4. The method of claim 1, wherein said combining a poly(arylene ether) with the temperature-adjusted solvent is conducted in an atmosphere comprising less than or equal to 10 kilopascals partial pressure of molecular oxygen.

5. The method of claim 1, wherein said combining a poly(arylene ether) with the temperature-adjusted solvent comprises adding the poly(arylene ether) to the solvent via an apparatus comprising a dispensing valve with an open/close controller, and a nitrogen-purged conduit.

6. The method of claim 5, wherein the apparatus further comprises a hopper and a rotary valve.

7. The method of claim 1, wherein said agitating to at least partially dissolve the poly(arylene ether) comprises agitating the combined poly(arylene ether) and solvent at about 50 to about 100° C. for about 10 to about 100 minutes.

8. The method of claim 1, wherein said agitating to at least partially dissolve the poly(arylene ether) comprises mixing with a mixing energy of about 10 to about 50 kilojoules per kilogram total of poly(arylene ether) and solvent.

9. The method of claim 8, further comprising heating the combined poly(arylene ether) and solvent with a heating energy of about 100 to about 250 kilojoules per kilogram total of poly(arylene ether) and solvent.

10. The method of claim 1, wherein said at least partially dissolving the poly(arylene ether) comprises dissolving at least about 80 weight percent of the poly(arylene ether).

11. The method of claim 1, wherein said combining a capping agent comprises adding the capping agent to the poly(arylene ether), solvent, and capping catalyst at a rate effective to maintain a temperature no more than 10° C. greater than a temperature in the absence of capping agent addition.

12. The method of claim 1, wherein said combining a capping agent comprises adding the capping agent in an amount comprising an excess to compensate for a water impurity in at least one of the solvent, the poly(arylene ether), and the capping catalyst.

13. The method of claim 1, wherein said combining a capping agent comprises using at least 0.8 mole of capping agent per 1 mole total for the sum of moles of phenolic end-groups in the poly(arylene ether), moles of water in the poly(aryiene ether), and moles of water in the solvent.

14. The method of claim 1, wherein the solvent is selected from the group consisting of halogenated aliphatic hydrocarbon solvents, aromatic hydrocarbon solvents, halogenated aromatic hydrocarbon solvents, and mixtures thereof.

15. The method of claim 1, wherein the solvent is toluene.

16. The method of claim 1, wherein the solvent is styrene.

17. The method of claim 1, wherein the capped poly(arylene ether) comprises repeating structural units having the formula 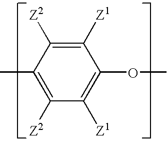
wherein for each structural unit, each Z¹ is independently halogen, unsubstituted or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; and each Z² is independently hydrogen, halogen, unsubstituted or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms.

18. The method of claim 1, wherein the capped poly(arylene ether) comprises 2,6-dimethyl-1,4-phenylene ether units, 2,3,6-trimethyl-1,4-phenylene ether units, or a combination thereof.

19. The method of claim 1, wherein the capped poly(arylene ether) has the structure 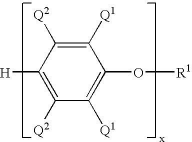
wherein x is 5 to about 100; each occurrence of Q¹ is independently halogen, unsubstituted or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; each occurrence of Q² and R⁶ and R⁷ is independently hydrogen, halogen, unsubstituted or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; and R¹ has the structure 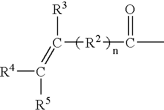
wherein n is 0 or 1, R² is C₁-C₁₂ hydrocarbylene, and R² and R³ and R⁴ are each independently hydrogen or C₁-C₁₈ hydrocarbyl.

20. The method of claim 1, wherein the capped poly(arylene ether) has the structure 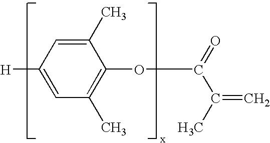
wherein x is 5 to about 100.

21. The method of claim 1, wherein the capped poly(arylene ether) has the structure 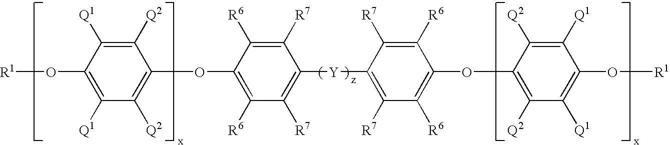
wherein z is 0 or 1; each occurrence of x is independently 1 to about 100; each occurrence of Q¹ is independently halogen, unsubstituted or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; each occurrence of Q² and R⁶ and R⁷ is independently hydrogen, halogen, unsubstituted or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; each occurrence of R¹ is independently 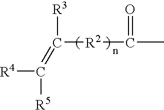
wherein n is 0 or 1, R² is C₁-C₁₂ hydrocarbylene, and R² and R³ and R⁴ are each independently hydrogen or C₁-C₁₈ hydrocarbyl; and Y has a structure selected from 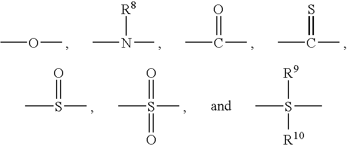
wherein each occurrence of R⁸, R⁹, and R¹⁰ is independently selected from hydrogen and C₁-C₁₂ hydrocarbyl.

22. The method of claim 1, wherein the capped poly(arylene ether) has the structure 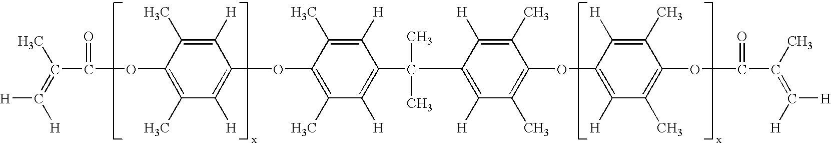
wherein each occurrence of x is independently 1 to about 50.

23. The method of claim 1, wherein the poly(arylene ether) has an intrinsic viscosity of about 0.05 to about 1.0 deciliter per gram, measured at 25° C. in chloroform.

24. The method of claim 1, wherein the poly(arylene ether) comprises a first poly(arylene ether) having an intrinsic viscosity of about 0.05 to less than 0.2 deciliter per gram and a second poly(arylene ether) having an intrinsic viscosity of 0.2 to about 0.6 deciliter per gram, wherein the intrinsic viscosities are measured at 25° C. in chloroform.

25. The method of claim 1, wherein the capping catalyst is selected from dialkylaminopyridines, pyrollidinopyridines, and mixtures thereof.

26. The method of claim 1, wherein said combining a poly(arylene ether) with the temperature-adjusted solvent comprises providing the poly(arylene ether) as powder and pellets.

27. The method of claim 1, wherein the capping agent has the structure 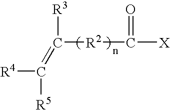
wherein each occurrence of R¹¹ is C₁-C₁₂ hydrocarbylene; each occurrence of R¹² is independently hydrogen or methyl; each occurrence of R¹³ and R¹⁴ are independently hydrogen or C₁-C₁₂ hydrocarbyl; m is 0 or 1; and X is selected from the group consisting of 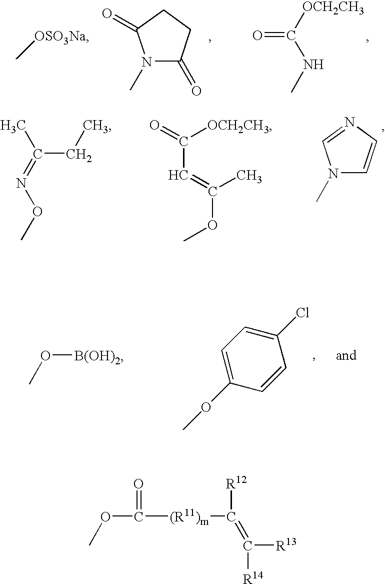
wherein R¹¹, R¹², R¹³, R¹⁴, and m are defined as above.

28. The method of claim 1, wherein the capping agent is methacrylic anhydride.

29. The method of claim 1, wherein said combining a capping agent comprises combining the capping agent with the poly(arylene ether), solvent, and capping catalyst over the course of about 10 to about 45 minutes.

30. The method of claim 1, wherein the solvent and the poly(arylene ether) are used in a weight ratio of about 1:3 to about 9:1, wherein the capping agent and the capping catalyst are used in a molar ratio of about 4:1 to about 10:1, and wherein the poly(arylene ether) and the capping agent are used in amounts such that a molar ratio of capping agent to hydroxy groups in the poly(arylene ether) is about 1.5:1 to about 5:1.

31. The method of claim 1, further comprising monitoring consumption of the poly(arylene ether) by measuring the intensity of an infrared absorbance associated with poly(arylene ether) phenolic hydroxy groups.

32. The method of claim 1, wherein the solvent is a polymerizable aromatic solvent selected from the group consisting of styrene, vinyltoluenes, divinylbenzenes, and mixtures thereof; and wherein the method further comprises combining a polymerization inhibitor with the solution of the capped poly(arylene ether).

33. The method of claim 1, further comprising isolating the capped poly(arylene ether) by a method selected from the group consisting of spray drying, precipitation, total isolation, devolatilizing extrusion, and combinations thereof.

34. The method of claim 1, further comprising precipitating the capped poly(arylene ether) by a method comprising combining the capped poly(arylene ether) solution with an antisolvent to form a combined mixture, wherein the combined mixture has a weight ratio of aromatic hydrocarbon solvent to antisolvent of about 2:1 to about 5:1.

35. A method of preparing a capped poly(arylene ether), comprising:
adjusting a temperature of an aromatic hydrocarbon solvent to a temperature in the range of about 40 to about 80° C.; wherein the aromatic hydrocarbon solvent is selected from the group consisting of toluene, styrene, and mixtures thereof;
combining a poly(arylene ether) with the temperature-adjusted solvent and agitating to dissolve at least 95 weight percent of the poly(arylene ether); wherein said combining a poly(arylene ether) with the temperature-adjusted solvent comprises adding the poly(arylene ether) to the solvent at a rate of about 0.4 to about 2 weight percent of the total poly(arylene ether) per minute; and wherein said combining a poly(arylene ether) is conducted in an atmosphere comprising less than or equal to 10 kilopascals partial pressure of molecular oxygen;
combining a capping catalyst with the combined poly(arylene ether) and solvent; wherein the capping catalyst comprises 4-dimethylaminopyridine;
combining a capping agent with the combined poly(arylene ether), solvent, and capping catalyst; wherein the capping agent is selected from the group consisting of acrylic anhydride, methacrylic anhydride, and mixtures thereof; and
maintaining the combined capping agent, poly(arylene ether), solvent, and capping catalyst at about 70 to about 100° C. for about 40 to about 120 minutes to form a solution of the capped poly(arylene ether).

36. A method of preparing a capped poly(arylene ether), comprising:
adjusting a temperature of an aromatic hydrocarbon solvent to about 40 to about 80° C.; wherein the aromatic hydrocarbon solvent is selected from the group consisting of toluene, styrene, and mixtures thereof;
combining a poly(arylene ether) with the temperature-adjusted solvent and agitating to dissolve at least 95% of the poly(arylene ether); wherein said combining a poly(arylene ether) is conducted in an atmosphere comprising less than 10 kilopascals partial pressure of molecular oxygen; wherein said combining a poly(arylene ether) with the temperature-adjusted solvent comprises adding the poly(arylene ether) to the solvent at a rate of about 0.4 to about 2 weight percent of the total poly(arylene ether) per minute; and wherein the solvent and the poly(arylene ether) are used in a weight ratio of about 1:1 to about 3:1;
combining a capping catalyst with the combined poly(arylene ether) and solvent; wherein the capping catalyst comprises 4-dimethylaminopyridine; wherein the capping agent and the capping catalyst are used in a molar ratio of about 4:1 to about 10:1, and wherein the poly(arylene ether) and the capping agent are used in amounts such that a molar ratio of capping agent to hydroxy groups in the poly(arylene ether) is about 2:1 to about 4:1;
combining a capping agent with the combined poly(arylene ether), solvent, and capping catalyst; wherein the capping agent comprises methacrylic anhydride; and
maintaining the combined capping agent, poly(arylene ether), solvent, and capping catalyst at about 70 to about 100° C. for about 40 to about 120 minutes to form a solution of the capped poly(arylene ether).
